(19) United States
(12) Patent Application Publication
(10) Pub. No.: US 2014/0375072 A1
(43) Pub. Date: Dec. 25, 2014

(54) GRIPPER DEVICE HAVING HOLDING POINTS

(71) Applicant: Korea Pneumatic System Co., Ltd., Seoul (KR)

(72) Inventor: Ho-Young Cho, Seoul (KR)

(73) Assignee: KOREA PNEUMATIC SYSTEM CO., LTD., Seoul (KR)

(21) Appl. No.: 14/372,253

(22) PCT Filed: Dec. 12, 2012
(86) PCT No.: PCT/KR2012/010764

§ 371 Date: Jul. 15, 2014

(30) Foreign Application Priority Data
Jan. 17, 2012 (KR) 10-2012-005423

(51) Int. Cl. B25J 15/06; B25J 15/00

(52) U.S. Cl. CPC B25J 15/0616; B25J 15/0052; B25J 15/0608; Y10S 901/31; Y10S 901/40
USPC 294/188; 294/81.6; 294/65.5; 901/31; 901/40

(57) ABSTRACT

The present invention relates to a gripper device which has multiple holding points. The gripper device according to the present invention comprises: a frame comprising a rotating shaft which is arranged in parallel; a holding means fixed by a bracket to one holding point on the rotating shaft; and a driving means which rotates the rotating shaft and the holding means. The gripper device effectively responds to holding points which vary depending on the type of article held so that the articles can be stably held.

### TECHNICAL FIELD

The present invention relates, in general, to gripper devices for lifting and transferring objects and, more particularly, to a gripper device having a holding point which is provided with a rotatable holding unit.

### BACKGROUND ART

Generally, in industrial sites, materials are frequently processed in such a way that they are transferred in stages. For instance, in a site for producing vehicles, a bonnet or an upper plate of a vehicle body is produced through several pressing processes. This sort of object is relatively heavy and has a comparatively large surface area. Therefore, a gripper device having a plurality of holding points is used to reliably grip an object in transferring it between stages. The gripper device is connected to a robotic apparatus so that the object can be lifted and transferred.

In conventional vacuum transfer systems, a vacuum pad is used as a holding unit provided on each holding point. For example, devices introduced in Korean Patent Nos. 883882 and 932775 can be used as the holding unit. Meanwhile, representative examples of the gripper device are proposed in US Patent No. 2008/0111388, entitled “MATERIAL HANDLING DEVICE WITH LEVEL INDICATOR”, and Korean Patent Unexamined Publication No. 2011-126819, entitled “SUCTION DEVICE FOR TRANSFERRING PANEL”.

In the above examples, objects are changed in form, shape, weight, center of gravity, etc. depending on the kinds of vehicles. Of course, the holdings points are also changed. Therefore, if the gripper device has holding points that are set only to a single form, it cannot appropriately cope with various kinds of objects. Given this, in production sites, different kinds of gripper devices that have predetermined holding points set in different forms are prepared, and any one of the gripper devices is used as needed.

However, in this case, preparing different kinds of gripper devices increases a financial burden. Replacing one gripper device with another kind of gripper device causes time loss, thus reducing productivity. Despite such circumstances, there are no particular measures currently known to remedy this problem.

Furthermore, stationary holding units may come into contact with surrounding structures when the gripper device moves through relatively small spaces between the surrounding structures. In order to avoid this, the conventional gripper device needs to be used in a comparatively large space. However, this is a huge issue within a workspace having a limited size.

### DISCLOSURE

### Technical Problem

Accordingly, the present invention has been made keeping in mind the above problems occurring in the prior art, and an object of the present invention is to provide a gripper device having a holding point which is configured to effectively cope with conditions of various kinds of objects, whereby the single gripper device can reliably grip objects of various sizes and shapes.

Another object of the present invention is to provide a gripper device which has a compact shape so that it can easily move even in a relatively small space.

### Technical Solution

In order to accomplish the above objects, the present invention provides a gripper device having a holding point, including:

a pole connected at an end thereof to a robotic apparatus;

a frame having a plurality of support bars coupled to the pole and extending in a direction perpendicular to the pole, the support bars being arranged parallel to each other at positions spaced apart from each other, and rotating shafts installed between the support bars and arranged parallel to the pole;

a holding unit fixed to each of holding points on the rotating shafts by a bracket; and

a drive unit individually rotating each of the rotating shafts so that the corresponding holding unit is rotated.

Preferably, the gripper device may further include a stationary holding unit provided on another holding point formed on the frame, rather than on one of the holding points of the rotating shafts. The holding unit may include any one selected from among a vacuum gripper, a magnet gripper and a mechanical gripper. The drive unit may include any one selected from among a rotary actuator, a motor and a cylinder.

Preferably, he holding unit may comprise a vacuum gripper. The vacuum gripper may include:

a pipe-shaped body including a ball-joint in a lower end thereof, with a discharge passage formed in the pipe-shaped body;

a vacuum cup including a reverse L-shaped ring covering an upper portion of the vacuum cup, the vacuum cup being rotatably coupled to the ball-joint and communicating with the discharge passage; and

an elastic member supported at an end thereof on the body, the elastic member elastically compressing the ring.

### Advantageous Effects

A gripper device according to the present invention has a plurality of holding points and holding units which are disposed at the respective holding points. The holding units that are provided on rotating shafts can be rotated along with the rotating shafts by 90° or 180°. Therefore, whether each holding unit is used to grip a specific object can be optionally determined. Thus, the gripper device according to the present invention can effectively cope with holding points which are changed depending on the kinds of objects, whereby various the gripper device can reliably grip various shapes and sizes of objects.

The above-mentioned effect can be achieved by the holding units that are configured so as to be rotatable. Because of this configuration, the holding units can be retracted into the gripper device such that they do not protrude outwards from the gripper device. Therefore, the gripper device can be easily moved even in a small space.

In a preferred embodiment, the holding unit comprises a vacuum gripper. The vacuum gripper is configured such that a vacuum cup can rotate and move upwards or downwards. Therefore, even when the surface of an object is uneven, the vacuum gripper can appropriately cope with the conditions of the surface of the object and thus reliably grip it.

### DESCRIPTION OF DRAWINGS

FIG. 1 is a perspective view illustrating the construction of a gripper device according to the present invention;

FIG. 2 is a sectional view showing a holding unit used in FIG. 1; and

FIG. 3 is a view showing the operation of FIG. 2.

### DESCRIPTION OF THE REFERENCE NUMERALS IN THE DRAWINGS

10. gripper device

11. pole 12. frame

13,13a. holding unit 14. support bar

15,16,17,18. rotating shaft

20,21. bracket 22. drive unit

30. holding unit main body 31. housing

32. through-hole 33. pipe

34. inclined surface 35. inlet

36. locking means 37. chuck

38. 39. push part

40. elastic member 41. spring

50. vacuum gripper 51. body

52. ball-joint 53. vacuum cup

34. ring 55. elastic member

56. passage

S. inner space

### BEST MODE

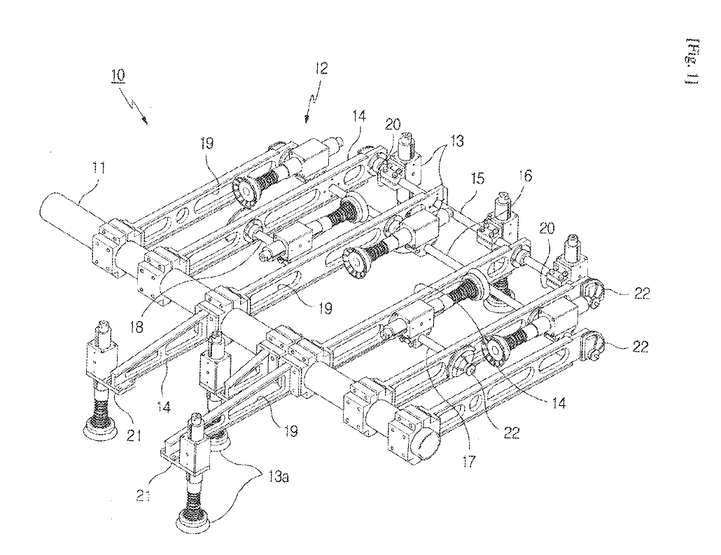

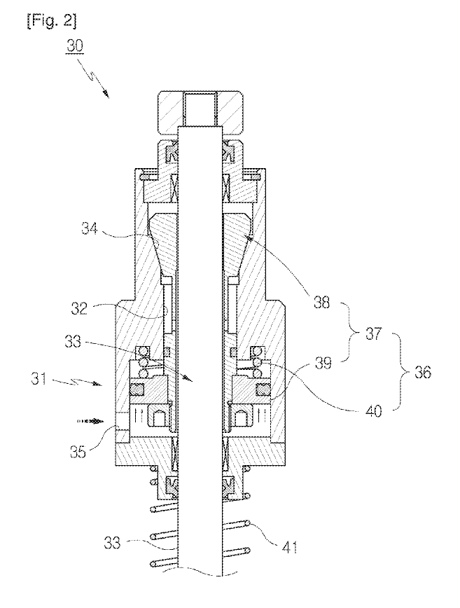

The above and other objects, features and advantages of the present invention will be more clearly understood from the following detailed description taken in conjunction with the accompanying drawings. FIG. 1 is a perspective view illustrating the construction of a gripper device according to an embodiment of the present invention. FIG. 2 is a sectional view showing a holding unit used in FIG. 1.

Referring to FIG. 1, a gripper device having holding points according to the embodiment of the present invention is designated by reference numeral 10. The gripper device 10 includes a pole 11, a frame 12 which is coupled to the pole 11, and holding units 13 and 13a which are disposed at respective holding points formed on the frame 12. Although this embodiment is illustrated as having a plurality of holding points, a single holding point may be provided in another embodiment.

The pole 11 extends a predetermined length and is coupled on an outer circumferential surface thereof to the frame 12. An end of the pole 11 is connected to a robotic transfer apparatus. Thus, the gripper device 10 and an object gripped by the gripper device 10 can be transferred to a desired place.

The frame 12 includes a plurality of support bars 14 and two or more rotating shafts 15, 16, 17 and 18. Each support bar 14 is perpendicularly coupled to the pole 11 by a clamp 15 mounted on the outer circumferential surface of the pole 11. The support bars 14 are arranged parallel to each other at positions spaced apart from each other. Each support bar 14 has a plate shape. Preferably, one or more cut holes 19 are formed in the support bar 14 so as to reduce the weight of the frame 12.

The two or more rotating shafts 15, 16, 17 and 18 are installed between the support bars 14 and are arranged parallel to the pole 11 at positions spaced apart from each other. As shown in the drawings, there is no need for the rotating shafts 15, 16, 17 and 18 to have the same length. Furthermore, as shown by reference numerals 15 and 16, each rotating shaft may be installed in such a way as to pass through the two or more support bars 14. Alternatively, as shown by reference numerals 17 and 18, each rotating shaft may be installed between two adjacent support bars 14.

In this embodiment, the holding units 13 and 13a are respectively fixed to holding points formed on the rotating shafts 15, 16, 17 and 18 and to holding points formed on the frame 12 by brackets 20 and 21. One or more holding units 13 are provided on each rotating shaft 15, 16, 17, 18. The holding units 13 that are fixed to the holding points formed on the rotating shafts 15, 16, 17 and 18 are rotated along with rotation of the rotating shafts. The other holding units 13a do not have to be configured so as to be rotatable.

In other words, as needed, the holding units 13a that are provided on the holding points formed on the frame 12 rather than on the holding points formed on the rotating shafts 15, 16, 17 and 18 may be configured so as to be stationary as illustrated in this embodiment. In this embodiment, although each holding unit 13, 13a is illustrated as including a vacuum gripper called a suction cup or suction pad, a magnet or mechanical gripper may be selectively used as the holding unit depending on the kind of target object.

In the present invention, each rotating shaft 15, 16, 17, 18 is coupled at an end thereof to a separate drive unit 22 for rotating the corresponding rotating shaft. The drive units 22 are separately provided on the respective rotating shafts 15, 16, 17 and 18. For instance, a rotary actuator, a motor, a cylinder or other well known rotating shaft driving devices can be selectively used as each drive unit. The holding units 13 are rotated along with the corresponding rotating shafts 15, 16, 17 and 18 that are respectively rotated by the drive units 22.

Fixed to the rotating shaft designated by reference numeral 15, the holding unit 13 is oriented downwards and perpendicular to the support bar 14. On the other hand, the holding units 13, fixed to the rotating shafts designated by reference numerals 16, 17 and 18, are oriented parallel to the support bar 14. This is possible because each rotating shaft 15, 16, 17, 18 individually rotates. Thereby, among all of the holding units 13, at least one holding unit to be used for gripping a specific object can be optionally determined.

In another embodiment, if there is only one holding point, only a single holding unit 13 is provided and configured such that it can be determined whether it is in use for gripping an object or is not in use.

In this embodiment, the holding units 13, fixed to the holding points provided on the rotating shaft 15, and the other holding units 13a, fixed to the holding points provided on the frame 12 or the support bar 14, are set as being used to hold an object. To effectively cope with holding points varying according to the kind of object, the holding points of the gripper device can be set or changed in various ways by individually operating the drive units 22 and the rotating shafts 15, 16, 17 and 18.

After the above-mentioned setting process has been completed, the pole 11 is moved downwards by the robotic system, so that the holding units 13 and 13a set as described above come into contact with the surface of the object. In this way, the gripper device 10 according to the present invention grips the corresponding object. Here, because there may be a stepped or curved portion in the surface of the object depending on the kind of object, the holding units 13 and 13a must be able to cope with such a case and stably grip the object to reliably ensure transfer of the object.

FIG. 2 illustrates a main body 30 of each holding unit 13, 13a. The main body 30 includes: a hollow housing 31 which is provided with the bracket 20 or 21; a pipe 33 which is connected at an end thereof to a gripping part and is provided passing through the housing 31 so as to be movable in an axial direction; and an elastic spring 41, both ends of which are respectively supported on the housing 31 and the gripping part. The gripping part comprises a vacuum gripper, a magnet gripper or a mechanical gripper which come into direct contact with the object.

In the above structure, the gripping part is moved upwards or downwards along with the pipe 33 and supported by the spring 39. Therefore, even if the surface of the object which is brought into contact with the gripping parts of the holding units is partly uneven, the gripping parts can appropriately cope with the surface of the object so that the gripper device can reliably grip the object. However, it is necessary to fix the position of the pipe 33 after the height thereof is adjusted. For this, preferably, a locking means for fixing the pipe 33 is installed in the housing 31.

In detail, the housing 31 has an inclined surface 34 which is formed at a predetermined position on an inner surface of a central through-hole 32 and configured such that the diameter thereof is increased from one side to the other side, and an air inlet 35 which is formed to supply compressed air into the housing 31. The locking means 36 is disposed coaxially with the pipe 33 between the housing 31 and the pipe 33. The locking means 36 includes a chuck 37 which is moved by pressure of compressed air, and an elastic member 40 which elastically supports the chuck 37 and returns the chuck 37 to its original position.

The chuck 37 is provided around a circumferential surface of the pipe 33. The chuck 37 includes a jaw 38 which is configured such that the diameter thereof can be reduced or extended and thus be brought into contact with the surface of the pipe 33 or be removed therefrom. Reducing or extending the diameter of the jaw 38 is embodied by bringing an inclined outer surface of the jaw 38 into contact with the inclined surface 34 of the housing 31 or removing the inclined outer surface therefrom while the chuck 37 is sliding along the pipe 33. Reference numeral 39 denotes an air push part which has an annular flange shape and is coupled to an end of the chuck 37 that is opposite to the jaw.

The push part 39 is configured to receive the pressure of compressed air supplied into the housing 31 through the inlet 35 and to slide the entirety of the chuck 37 along the pipe 33. In the locking means 36 that is coaxially disposed between the housing 31 and the pipe 33, the push part 39 is positioned at a position corresponding to the air inlet 35 of the housing 31.

In this state, when the pressure of compressed air into the housing 31 through the inlet 35 is transmitted to the push part 39, the chuck 37 is moved upwards (refer to the arrows of the drawing). Then, the jaw 38 is removed from the inclined surface 34 of the housing 31, thus releasing the pipe 33 that has been locked to the jaw 38. As a result, the pipe 33 is allowed to be moved. When the supply of compressed air is interrupted, the chuck 37 is moved downwards by the elastic member 40 and returned to its original position. During this process, the jaw 38 is brought into slide contact with the inclined surface 34 of the housing 31 and thus is reduced in diameter, whereby the pipe 13 is locked to the jaw 38.

In another embodiment, the inlet 35 and the elastic member 20 may be switched in position with each other based on the push part 39. In this case, on the contrary to the above-described embodiment, when compressed air is supplied, the pipe 13 is locked, and when the supply of compressed air is interrupted, the pipe 13 is released.

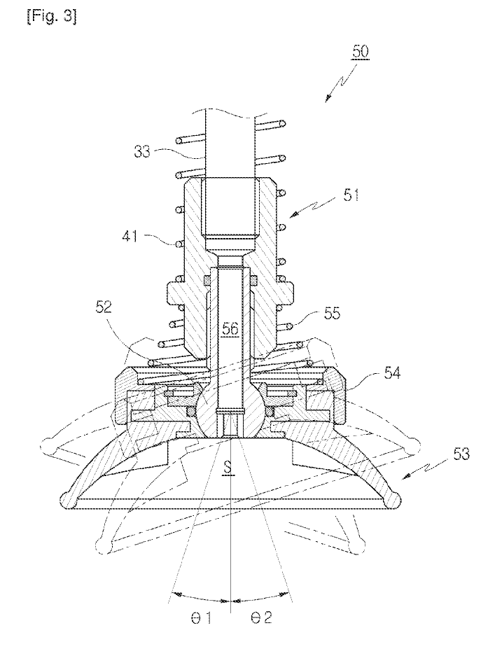

Referring to FIG. 3, preferably, the gripping part comprises a vacuum gripper 50 which comes into direct contact with the object. The vacuum gripper 50 includes: a pipe-shaped body 51 which has a ball-joint 52 on a lower end thereof; a vacuum cup 53 which has a reverse L-shaped ring 54 covering an upper portion of the vacuum cup and is rotatably coupled to the ball-joint 52; and an elastic member 55 which is supported at an end thereof on a portion of an outer circumferential surface of the body 51 and elastically compresses the ring 54. An air discharge passage 56 in the body 51 communicates with an inner space S of the vacuum cup 53.

In this structure, the vacuum cup 53 can rotate around the ball-joint 52 within a predetermined angular range (θ1 and θ2). The vacuum cup 53 is supported by the elastic member 55 that is embodied by the spring. Therefore, even if the surface of the object that is brought into direct contact with the vacuum cup 53 is partly uneven or is inclined, the vacuum cup 53 can appropriately cope with the conditions of the surface of the object and thus reliably come into close contact with it. The ring 54 is designed so as to be movable upwards or downwards, whereby the body 51 and the vacuum cup 53 can be separably assembled with each other.

The vacuum gripper 50, having the body 51 provided with the bracket 20 or 21, can be used as the single holding unit 13 or 13a in the gripper device 10 according to the present invention. To embody a vacuum transfer system, the passage 56 of the body 51 is connected to a suction port of a vacuum pump.

In this embodiment, each holding unit 13, 13a is configured by assembling the gripper 50 of FIG. 3 with the main body 30 of FIG. 2. That is, the corresponding end of the pipe 33 of the main body 30 is coupled to the body 51 of the vacuum gripper 50 that is provided as the gripping part. The pipe 33, the passage 56 of the body 51 and the inner space S of the vacuum cup 53 communicate with each other. This coupling structure makes it possible both to rotate the vacuum cup 33 and to adjust the vertical position of the vacuum cup 33. In this case, the suction port of the vacuum pump is connected to the pipe 33.

1. A gripper device having a holding point, comprising:
a pole (11) connected at an end thereof to a robotic apparatus;
a frame (12) including: a plurality of support bars (14) coupled to the pole and extending in a direction perpendicular to the pole, the support bars (14) being arranged parallel to each other at positions spaced apart from each other; and rotating shafts (15), (16), (17) and (18) installed between the support bars and arranged parallel to the pole;
a holding unit (13) fixed to each of holding points on the rotating shafts (15), (16), (17) and (18) by a bracket (20); and
a drive unit (22) individually rotating each of the rotating shafts (15), (16), (17) and (18) so that the corresponding holding unit (13) is rotated.

2. The gripper device of claim 1, further comprising
a stationary holding unit (13a) provided on another holding point formed on the frame (12), rather than on one of the holding points of the rotating shafts.

3. The gripper device of claim 1, wherein the holding unit (13) comprises any one selected from among a vacuum gripper, a magnet gripper and a mechanical gripper.

4. The gripper device of claim 1, wherein the drive unit (22) comprises any one selected from among a rotary actuator, a motor and a cylinder.

5. The gripper device of claim 1, wherein the frame (12) has at least one cut hole (19) to reduce a weight thereof.

6. The gripper device of claim 1, wherein the holding unit (13) that is fixed to the corresponding rotating shaft and rotated along therewith is oriented downwards perpendicular to the support bars (14) or oriented parallel to the support bars (14).

7. The gripper device of claim 1, wherein the holding unit (13) comprises:
a hollow housing (31);
a pipe (33) connected at an end thereof to a gripping part, the pipe (33) being provided passing through the housing (31) so as to be movable upwards or downwards in an axial direction; and
an elastic spring (41) supported at opposite ends thereof on the housing (31) and the gripping part,
wherein the gripping part comprises any one selected from among a vacuum gripper, a magnet gripper and a mechanical gripper.

8. The gripper device of claim 1, wherein the holding unit (13) comprises:
a housing (31) having: a central through-hole (32) longitudinally formed in the housing; an inclined surface (34) formed at a predetermined position on an inner surface of the central through-hole, the inclined surface being configured such that a diameter thereof is increased from a first side to a second side; and an air inlet (35) through which compressed air is supplied into the housing;
a pipe (33) provided passing through the through-hole so as to be movable in an axial direction; and
a locking means (36) coaxially disposed between the housing and the pipe,
wherein the locking means comprises:
a chuck (37) including: a jaw (38) provided around a surface of the pipe, the jaw having a side surface inclined to correspond to the inclined surface (34) of the housing so that when the side surface of the jaw moves and comes into sliding contact with the inclined surface (34) of the housing, a diameter of the jaw is reduced whereby the jaw compresses the surface of the pipe (33) so that the pipe (33) is locked to the jaw; and a push part (39) disposed at a position corresponding to the air inlet (35) of the housing, the push part (39) being provided to move the jaw in the axial direction; and
an elastic member (40) elastically moving the chuck and returning the chuck to an original position thereof.

9. The gripper device of claim 1, wherein the holding unit (13) comprises a vacuum gripper (50),
the vacuum gripper (50) comprising:
a pipe-shaped body (51) including a ball-joint (52) in a lower end thereof, with a discharge passage (56) formed in the pipe-shaped body (51);
a vacuum cup (53) including a ring (54) covering an upper portion of the vacuum cup, the vacuum cup (53) being rotatably coupled to the ball-joint (52) and communicating with the discharge passage (56); and
an elastic member (55) supported at an end thereof on the body (51), the elastic member (55) elastically compressing the ring (54).

10. The gripper device of claim 9, wherein the ring (54) comprises a reverse L-shaped ring.

11. The gripper device of claim 9, wherein the ring (54) is designed so as to be movable upwards or downwards, whereby the body (51) and the vacuum cup (53) can be separably assembled with each other.

12. The gripper device of claim 1, wherein the holding unit (13) comprises:
a hollow housing (31);
a pipe (33) connected at an end thereof to a gripping part, the pipe (33) being provided passing through the housing (31) so as to be movable upwards or downwards in an axial direction; and
an elastic spring (41) supported at opposite ends thereof on the housing (31) and the gripping part,
wherein the gripping part comprises a vacuum gripper (50),
the vacuum gripper (50) comprising:
a pipe-shaped body (51) including a ball-joint (52) in a lower end thereof, with a discharge passage (56) formed in the pipe-shaped body (51);
a vacuum cup (53) including a ring (54) covering an upper portion of the vacuum cup, the vacuum cup (53) being rotatably coupled to the ball-joint (52) and communicating with the discharge passage (56); and
an elastic member (55) supported at an end thereof on the body (51), the elastic member (55) elastically compressing the ring (54).
